(19) United States
(12) Patent Application Publication
(10) Pub. No.: US 2026/0149672 A1
(43) Pub. Date: May 28, 2026

(54) QUEUE DEPTH MONITORING DEVICES AND METHODS

(71) Applicant: EQUINIX INC., Redwood City, CA (US)

(72) Inventor: Reshad Rahman, Ottawa (CA)

(73) Assignee: EQUINIX INC., Redwood City, CA (US)

(21) Appl. No.: 18/962,788

(22) Filed: Nov. 27, 2024

(51) Int. Cl. H04L 47/62

(52) U.S. Cl. CPC H04L 47/624

(57) ABSTRACT

A node of a network includes a network interface configured to receive outgoing bidirectional forward detection (BFD) echo packets transmitted from an originating node and to transmit return BFD echo packets with queue depth information appended thereto back to the originating node; a queue depth information generator configured to collect queue depth information; and a processor configured to append the queue depth information to the outgoing BFD echo packets. Other apparatus and methods are disclosed.

### FIELD OF THE DISCLOSURE

The present disclosure relates generally to networks for data communications. In particular, but not by way of limitation, the present disclosure relates to systems, methods, and apparatuses for providing real time queue depth status of nodes in communications networks.

### BACKGROUND

Communications networks route data between points in the networks by way of many different communications paths. The networks include nodes that are in communications with each other to create the communications paths. When a node has a high queue depth, that node may become congested and not be able to rapidly transfer data and may cause high latency or other issues in that communications path. Applications relying on data communications in that communications path may not be able to operate efficiently due to the latency.

An example of high queue depth is when a node receives more data than the node can process (e.g., transfer). The node may then be considered congested. In order to overcome the high queue depth, the node may send a signal to other nodes transmitting data to the congested node indicating that data transmissions to the congested node must temporarily cease or be reduced. One such protocol for ceasing or reducing data transmission to the congested node is proactive flow control (PFC). However, PFC may not relieve congestion on a network fast enough for the network to provide high data rates for applications such as machine learning and artificial intelligence. Therefore, a need exists for apparatus and methods that enable networks to monitor and alleviate network congestion in real time.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

In some aspects, a node of a network is disclosed. The node includes: a network interface configured to receive outgoing bidirectional forward detection (BFD) echo packets transmitted from an originating node and to transmit return BFD echo packets with queue depth information appended thereto back to the originating node; a queue depth information generator configured to collect queue depth information related to at least the node; and a processor configured to append the queue depth information to the outgoing BFD echo packets.

In some other aspects, a node of a network is disclosed, wherein the node includes: a network interface configured to receive return bidirectional forward detection (BFD) echo packets with queue depth information appended thereto from at least a first node of the network; and a processor coupled to the network interface, wherein the processor is configured to extract the queue depth information from the return BFD echo packets.

In some aspects, the techniques described herein relate to a method of operating a network, the method including: providing a network having at least a first node and a second node; acquiring first queue depth information pertaining to the second node; transmitting outgoing BFD echo packets from the first node to the second node; receiving the outgoing BFD echo packets in the second node; appending the first queue depth information to at least one return BFD echo packet; and transmitting the at least one return BFD echo packet with the first queue depth information appended thereto to the first node.

In yet other aspects, a network for transmitting data is disclosed. The network includes a first node and a second node. The first node is configured to: transmit outgoing BFD echo packets to the second node; receive return BFD echo packets from the second node; and extract first queue depth information from the return BFD echo packets. The second node is configured to: receive the outgoing BFD echo packets from the first node; append the first queue depth information to the return BFD echo packets; transmit the return BFD echo packets back to the first node.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a schematic block diagram of a network that has a plurality of data paths extending between a first node and a second node according to one or more embodiments;

FIG. 2 illustrates a schematic block diagram of a first path in the network of FIG. 1 according to one or more embodiments;

FIG. 3 illustrates a schematic diagram of a node in the first path of FIG. 2, wherein the node is configured to transmit and receive BFD echo packets according to one or more embodiments;

FIG. 4 is a flowchart describing a method of operating the node of FIG. 3 according to one or more embodiments;

FIGS. 5A-5C illustrate an example of a round robin or daisy chain data transmission that may be applied to the data path of FIG. 2 according to one or more embodiments;

FIG. 6 illustrates a block diagram of a node, such as an upstream end node that does not include a queue depth information generator, according to one or more embodiments;

FIG. 7 illustrates a block diagram of a node, such as a downstream end node, that does not include a BFD echo packet generator, according to one or more embodiments;

FIG. 8 illustrates a schematic block diagram of a network that has more nodes than the network of FIG. 1 according to one or more embodiments; and

FIG. 9 is a flowchart describing a method of operating a network according to one or more embodiments.

### DETAILED DESCRIPTION

Preliminary note: the flowcharts and block diagrams in the following figures illustrate the architecture, functionality, and operation of possible implementations of systems, methods and computer program products according to various embodiments of the present disclosure. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, components, and/or groups but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on,” “connected to,” “coupled to,” or “adjacent to” another element or layer, it can be directly on, connected, coupled, or adjacent to the other element or layer, or intervening elements or layers may be present. In contrast, when an element is referred to as being “directly on,” “directly connected to,” “directly coupled to,” or “immediately adjacent to” another element or layer, there are no intervening elements or layers present.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

Unless specifically stated otherwise, it is appreciated that throughout this specification, discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a circuit, module, or system. Furthermore, aspects of the present disclosure may take the form of a computer program product embodied in one or more computer readable medium(s) having computer readable program code embodied thereon.

Many communications networks transfer data via a plurality of communications paths (sometime referred to herein simply as “paths”) between points (e.g., nodes) of the networks. The communications paths are formed by way of a plurality of nodes, such as servers, routers, bridges, and switches. The nodes may include devices that transmit data to other nodes, receive data from other nodes, generate data (e.g., data packets), process data, and/or route data between different nodes and/or endpoints. In order to optimize data transfers between the nodes, certain data routing devices in the network may determine the optimal communications paths based at least partially on latency in the communications paths. High latency in a communications path may be the result of high queue depths or high buffer/queue depths associated with one or more nodes in the communications path. The devices that select the optimal communications paths may select data communications paths with minimal latency, such as communications paths having nodes with low queue depths.

Conventional networks may wait until congestion on a communications path increases latency significantly before the network moves data communications to alternative communications paths. For example, some conventional networks may use priority-based flow control or proactive flow control (PFC) when network congestion gets above a threshold. When a node in a network using PFC is becoming congested, such as the queue depth has increased above a threshold, the PFC protocol may cause an instruction to be transmitted to one or more upstream nodes that causes the upstream nodes to temporarily cease transmitting packets or reduce the rate of data packet transmissions to the congested node. However, PFC only acts when the network or nodes therein have high queue depths or are otherwise congested. During periods when the data communications are ceased, the network may encounter additional congestion due to the cease in data communications. In addition, when data communications resume, the previously congested node may experience a surge in data communications, which may cause continued congestion.

The networks described herein may monitor queue depths of a plurality or all nodes in a network to determine whether there are trends in queue depths that may result in lower or higher latency. In some embodiments, the network may use dynamic load balancing to transfer some data communications from high latency communications paths to low latency communications paths in response to analyzing the queue depth trends. Therefore, by monitoring queue depth trends, the network devices may anticipate data communications congestion and reroute data via alternate communications paths before the congestion causes issues with applications relying on fast data communications. The dynamic load balancing described herein may rely on local link loads in addition to remote queue depth information from remote nodes.

In order to monitor queue depth changes and quickly change data communications paths, the queue depths of the network nodes may need to be continuously monitored. In some embodiments efficient data routing may require the queue depths to be monitored in real time. Conventional devices and methods used to monitor networks do not provide fast or real time monitoring that enables high data applications, such as artificial intelligence (AI) or machine learning (ML) applications, to operate efficiently. Some conventional devices and methods transfer large quantities of data pertaining to performance metrics throughout the networks, which increases data traffic, especially as the networks increase in size and complexity. Additionally, these conventional devices and methods may not be able to monitor the networks with the high reliability and speed requirements of (AI) and (ML) applications.

The devices and methods described herein overcome issues with conventional network monitoring devices and methods by appending queue depth information (sometimes referred to as buffer/queue information) to return bidirectional forwarding detection (BFD) echo packets to quickly transfer queue depth information throughout the networks. The queue depth status of the nodes in a network may then be continuously updated in substantially real time. Data routing devices in the network may then select optimal communications paths in real time to accommodate applications such as AI and ML that require continuous high speed data transfers. In some embodiments, the queue depth information appended to the return BFD echo packets may be small so the additional load on the network due the transfer of the queue depth information is minimal.

The term queue depth may refer to the number of messages (e.g., packets) currently stored in a message queue of a node. Thus, the queue depth may be a measure of the number of messages that are waiting to be processed or consumed by the node. Several factors in the network and the individual nodes may affect the queue depths as described herein. The rate at which packets are being produced or sent to the queue in the receiving node directly impacts the queue depth of the receiving node. A high arrival rate of packets can quickly increase the queue depth, especially if a processing rate of the node is slow. If packets are processed faster than the packets arrive at a node, the queue depth of that node decreases. However, if processing is slower than the arrival rate of the packets, the queue depth of that node increases. The size of the packets can impact queue depth. Larger packets may take more time to process and consume more resources, which may cause higher queue depths. The availability of system resources in the nodes, such as processing speed and memory can impact the queue depth.

Queue depth information may include any data related to queue depth in the network 100. For example, queue depth information may include queue depths in one or more nodes in the network. The queue depth may also include average packet size and the time required to process packets, such as an average time. The queue depth information may include queue depths as a function of time, such as a table format of queue depths at certain times. Additionally, queue depth information may include trends in queue depths, such as increases or decreases in queue depths of individual nodes.

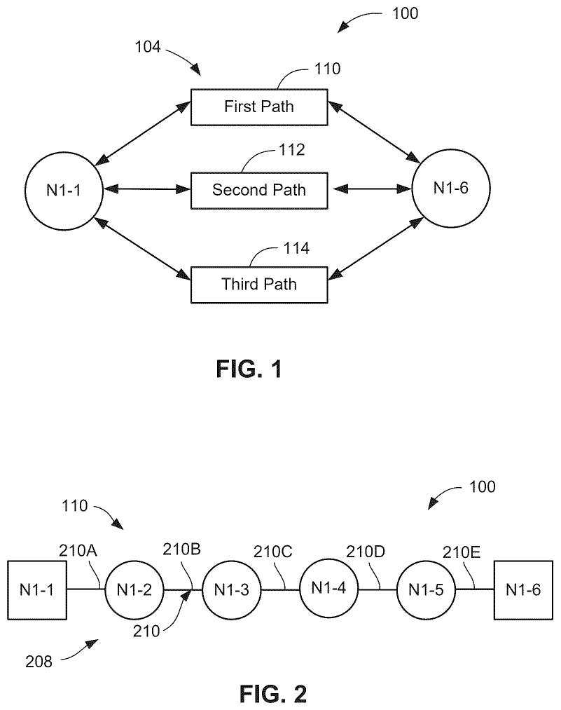

Reference is made to FIG. 1, which illustrates a network 100 configured to transfer data between a first node N1-1 and a sixth node N1-6 via a plurality of paths 104. In the embodiment of FIG. 1, the paths 104 include a first path 110, a second path 112, and a third path 114. In some embodiments, the network 100 may include two paths or more than three paths. Each of the paths 104 may include one or more nodes, such as switches, routers, bridges, and the like that transfer and/or process data. In the embodiments described herein, one or more of the nodes may be enabled to send outgoing bidirectional forwarding detection (BFD) echo packets. in addition, one or more of the nodes may be enabled to receive return BFD echo packets with appended queue depth information as described herein.

Additional reference is made to FIG. 2, which illustrates a diagram of an embodiment of the first path 110, that includes a plurality of nodes 208. The description of the first path 110 described here may be applicable to all the paths 104 in the network 100. In the embodiment of FIG. 2, four of the nodes 208 in the first path 110 are referred to as intermediate nodes and are coupled between the first node N1-1 and the sixth node N1-6. The intermediate nodes are referred to individually as a second node N1-2, a third node N1-3, a fourth node N1-4, and a fifth node N1-5. Examples of the intermediate nodes include routers, bridges, switches, and other devices that transfer and/or route data. The intermediate nodes transfer data between each other to facilitate data communications between the first node N1-1 and the sixth node N1-6. The intermediate nodes in the first path 110 are shown connected in series. Other network embodiments may include nodes connected in parallel or a combination of series and parallel connections.

In some embodiments, the nodes 208 may be servers or the like. For example, the first node N1-1 may be a server configured to run applications, such as AI or ML applications that require access to large memories, which may be in the sixth node N1-6. The devices and method described herein enable the servers to select and/or dynamically balance loads on the communications paths 104 to achieve efficient data transfer between the servers and other devices. The devices and methods described herein related to transferring queue depth information via BFD echo packets is applicable to other nodes or servers in the network 100.

A device in the network, such as the first node N1-1 may receive BFD echo packets with appended queue depth information of one or more devices in each of the paths 104. The first node N1-1 may analyze the queue depth information appended to the return BFD echo packets and, based at least in part on the queue depth information, select one or more of the paths 104 to transmit data to the sixth node N1-6. In some embodiments, the sixth node N1-6 may also receive queue depth information related to one or more devices in each of the paths 104 and may select a path, based at least in part on the queue depth information, to transmit data to the first node N1-1. Thus, path determination may be via dynamic load balancing from local link loads and from remote queue depth information from a plurality of the nodes, which may be remote nodes relative to the first node N1-1.

The first node N1-1 and the sixth node N1-6 may be any devices that receive, transmit, generate, and/or relay data. In some embodiments, the first node N1-1 and the sixth node N1-6 may be devices such as computers, smartphones, servers, cameras, and devices associated with the Internet of Things (IoT). The first node N1-1 and/or the sixth node N1-6 may be referred to as endpoint nodes of the network 100. For example, the first node N1-1 may be an upstream endpoint node and the sixth node N1-6 may be a downstream endpoint node.

The first path 110 may include a plurality of communications links 210 between the first node N1-1, the sixth node N1-6, and the intermediate nodes. In the embodiment of FIG. 2, the first path 110 includes a first communications link 210A between the first node N1-1 and the second node N1-2, a second communications link 210B between the second node N1-2 and the third node N1-3, a third communications link 210C between the third node N1-3 and the fourth node N1-4, a fourth communications link 210D between the fourth node N1-4 and the fifth node N1-5, and a fifth communications link 210E between the fifth node N1-5 and the sixth node N1-6. The communications links 210 may be combinations of wireless communication links (e.g., WIFI and satellite links) and/or wired links (e.g., ethernet cables).

The description of the transfer of queue depth information of the nodes 208 in the first path 110 as described herein is applicable to the transfer of queue depth information in other paths in the network 100. The queue depth information may be analyzed to provide latency and other quality of service parameters as to the communications quality between the first node N1-1 and the sixth node N1-6. Queue depth information may be transmitted throughout the first path 110 by being appended to return bidirectional forward detection (BFD) echo packets. In conventional networks, BFD echo packets are used to detect connectivity failures between two forwarding engines or nodes. BFD operates by transmitting outgoing BFD echo packets periodically to a node and checking whether the return BFD echo packets are received within a specified period.

When a node transmits an outgoing BFD echo packet, the node may be referred to as an originating node. The source and destination of the packet, which may be in the header of the packet, are the same, so the packet is returned to the sending or originating node. For example, with regard to the second communications link 210B between the second node N1-2 and the third node N1-3, the second node N1-2 may be an originating node and may transmit outgoing BFD echo packets with an internet protocol (IP) source of the second node N1-2, an IP destination of the second node N1-2, a media access control (MAC) source address of the second node N1-2, and a MAC destination address of the third node N1-3. When the BFD echo packets are received in the third node N1-3, the third node N1-3 echoes or returns the packets in its regular forwarding path wherein the IP source and destination do not change (second node N1-2), the MAC source address is the third node N1-3 and the MAC destination address is the second node N1-2. BFD echo packets are typically transmitted continuously and at a very high rate. For example, BFD echo packets may be transmitted continuously every 1 ms or 10 ms. BFD echo packets may be transmitted at higher or lower rates. The high rate of BFD echo packet transmissions with the appended queue depth information provides substantially real time network status to one or more nodes 208 of the network 100.

An example of queue depth information transmitted via return BFD echo packets is provided in a situation wherein the fifth node N1-5 may collect and/or generate queue depth and/or buffer information pertaining to the sixth node N1-6. In this example, the fifth node N1-5 may transmit outgoing BFD echo packets to the sixth node N1-6. Queue depth information stored in the sixth node N1-6 may be appended (e.g., encapsulated) to return BFD echo packets that are transmitted or returned to the fifth node N1-5. The queue depth information may include the queue depth, node, port, time of collection and other data related to queue depth. The fifth node N1-5 may extract (e.g., decapsulate) the queue depth information from the return BFD echo packets. Other nodes in the first path 110 and other paths in the network 100 may transmit queue depth information via BFD echo packets. The first node N1-1 or another node or device may analyze the first path 110 and the other paths in the network 100 and determine the optimal path for data transfer based at least partially on the queue depth information.

As described above, the originating node receiving the return BFD echo packets may analyze the appended queue depth information to determine queue depth information of different nodes in the first path 110. For example, one or more of the nodes 208 may collect queue depth information, such as via in-band or integrated operations, administration, and maintenance (IOAM) protocols. IOAM protocols collect operational and telemetry information (e.g., performance metrics) in packets while the packets traverse a path between two points in the network 100. The queue depth information may be decapsulated from the packets and stored in the nodes 208. The queue depth information may then be then appended to return BFD echo packets, which are returned to the originating nodes that transmitted the respective outgoing BFD echo packets. The queue depth information may then be extracted from the return BFD echo packets. In some embodiments, the queue depth information may be accumulated and analyzed, which provides an analysis (e.g., latency analysis) of the entire first path 110 and/or the network 100. BFD echo packets may be continuously transmitted, so the status of the network 100 is able to be continuously updated and monitored. The BFD process may operate at a high rate such that the network status may be monitored in real time or substantially in real time. For example, each node may transmit outgoing BFD echo packets at a rate of one per millisecond.

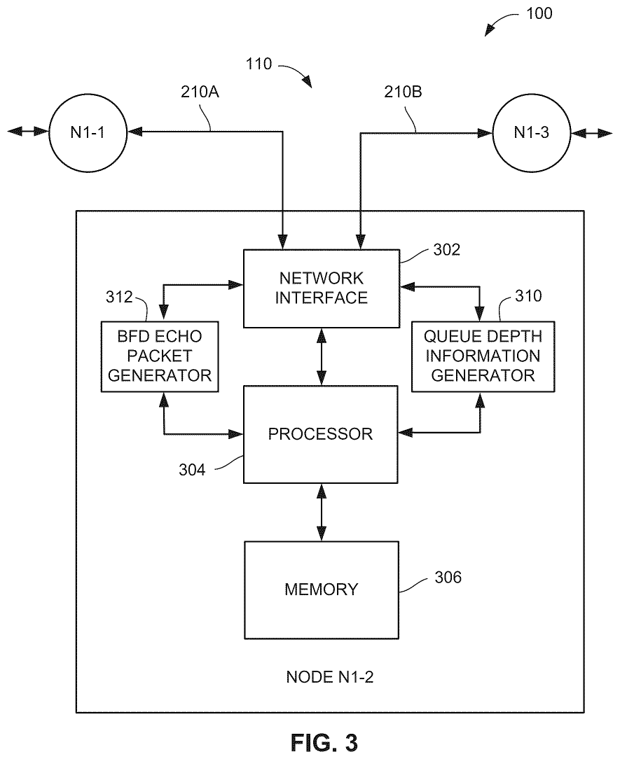

Having described embodiments of using BFD echo packets to transmit queue depth information throughout the first path 110, more detailed descriptions of the first path 110, the nodes 208, and the use of the BFD echo packets will now be provided. Additional reference is made to FIG. 3, which illustrates a block diagram of an embodiment of the second node N1-2. The description of the second node N1-2 described with reference to FIG. 3 may be applicable to other nodes and devices in the first path 110 and the network 100. It is noted that the first node N1-1 and the sixth node N1-6 may, in some embodiments, have different configurations and are described below. The nodes 208, including the first node N1-1 and the sixth node N1-6, are described as having individual components, such as network interfaces, BFD echo packet generators, processors, and memories. These individual components may be implemented on single circuits, such as single integrated circuits, as processors, or in firmware or software. Thus, some of the components described herein may be integrated together.

The second node N1-2 may include a network interface 302 that connects the second node N1-2 to the first path 110. For example, the network interface 302 may connect the second node N1-2 to the first communications link 210A and the second communications link 210B, which enables the second node N1-2 to communicate via the first path 110. Thus, the second node N1-2 may communicate directly with the first node N1-1 and the third node N1-3. The network interface 302 may capture packets transmitted via the first path 110 that are intended to be processed by the second node N1-2. The network interface 302 may also transmit packets onto the first path 110 with header information indicating the destinations of these packets. In that regard, the network interface 302 may transmit outgoing BFD echo packets and may receive return BFD echo packets. For example, the network interface 302 may return outgoing BFD echo packets transmitted from other nodes (e.g., the first node N1-1 and the third node N1-3) as described herein.

The second node N1-2 may include a processor 304 that is in communication with the network interface 302. In some embodiments, the network interface 302 may be integrated with the processor 304 or may be a processor. The processor 304 may perform actions required to operate the second node N1-2, which may include executing computer code to perform the actions. In other embodiments, the processor 304 may be programmed by software (e.g., computer code) to perform the actions, wherein the software may be received in the form of data originating from outside the second node N1-2. For example, a network administrator or the like may transmit software on the network 100, including the first path 110, that is received by the second node N1-2 and causes the second node N1-2 to perform at least some of the actions described herein. Software executed by the processor 304 may be stored in memory 306, which may be integrated into or in communication with the processor 304. The software may cause the processor 304 to analyze incoming packets and configure outgoing packets. With regard to the queue depths, the software may cause the processor 304 to append queue depth information and, in some embodiments, other performance data, to return BFD echo packets as described herein.

The processor 304 may also extract queue depth information from return BFD echo packets. The extracted queue depth information may be processed by the processor 304 to analyze and/or predict latency and other issues associated with queue depths of the first path 110 and/or the network 100. The processor 304 may also extract data that includes locations in the first path 110 where the queue depth information was obtained. For example, the extracted data may pertain to the queue depth of the third node N1-3. The extracted queue depth information and the locations where the queue depth information was obtained may be stored in the memory 306. The queue depth information may also be read from the memory 306 by the processor 304 and appended to return BFD echo packets as described herein.

The second node N1-2 may include a queue depth information generator 310 that may be configured to collect, analyze, and/or process queue depth information. Some of the queue depth information may be obtained or generated using IOAM processes. The queue depth information may pertain to queue depths of the second node N1-2, and/or other nodes in the first path 110 that have been transmitted to the second node N1-2. The queue depth information generator 310 may communicate with the processor 304 to store generated and/or collected queue depth information in the memory 306. In some embodiments, the queue depth information generator 310 may be implemented as software executed by the processor 304. In other embodiments, the queue depth information generator 310 may be implemented as firmware, hardware, or a processor.

In some embodiments, the queue depth information generator 310 may receive data packets containing queue depth information related to the second node N1-2 and/or other nodes and/or devices within the first path 110, such as remote devices and nodes. The queue depth information generator 310 may extract (e.g., decapsulate) the queue depth information from these data packets using, for example, conventional IOAM processing techniques. The queue depth information may then be stored or processed as described herein. In some embodiments, the queue depth information generator 310 may also process or transform queue depth information to a format that enables the queue depth information to be appended to return BFD echo packets as described herein.

The second node N1-2 may also include a BFD echo packet generator 312 that may generate outgoing BFD echo packets for transmission to the first node N1-1 and/or the third node N1-3. In some embodiments, the BFD echo packet generator 312 may be implemented as software executed by the processor 304. In other embodiments, the BFD echo packet generator 312 may be implemented in the processor 304 or the network interface 302. Accordingly, the processor 304 may generate the outgoing BFD echo packets or cause the BFD echo packet generator 312 to generate outgoing BFD echo packets. In some embodiments, the BFD echo packet generator 312 may append the queue depth information to return BFD echo packets. For example, the processor 304 may instruct the BFD echo packet generator 312 to append certain queue depth information to the return BFD echo packets for processing by the first node N1-1 or the third node N1-3. In some embodiments, the queue depth information and other performance metrics may be appended to the return BFD echo packets.

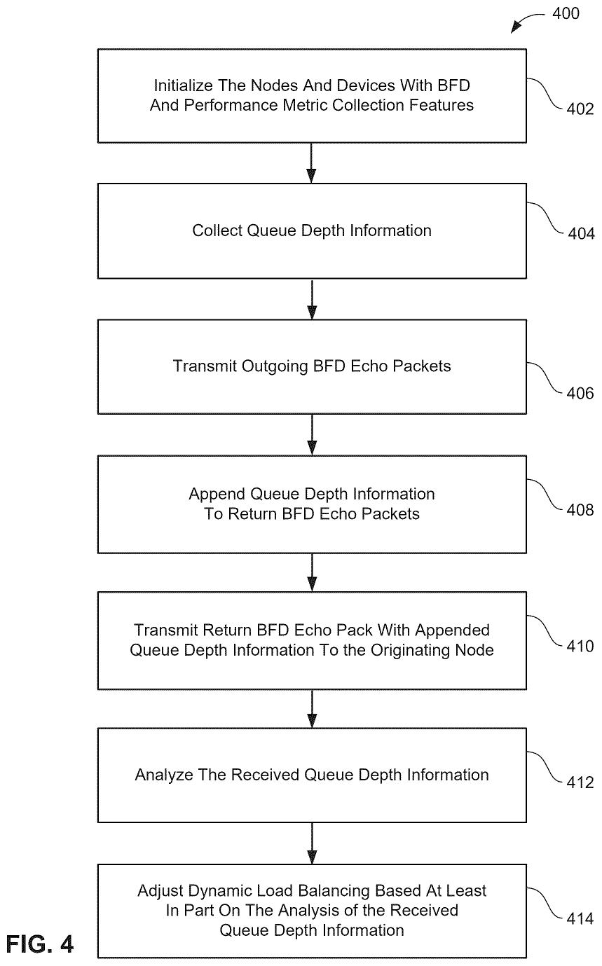

Having described the components of the second node N1-2, the operation of the second node N1-2 will now be described. The operation of the second node N1-2 may be identical or substantially similar to the operation of other nodes, such as other nodes 208 in the first path 110 and other nodes in the network 100. Additional reference is made to FIG. 4, which is a flowchart describing a method 400 of operating the second node N1-2.

The method 400 may commence with initializing one or more nodes 208 in the network 100 with BFD echo and queue depth information collection features per operational block 402. In some embodiments, at least one node in each of the paths 104 is initialized in order to enable the node to obtain at least some queue depth information regarding all the paths 104. In other embodiments several nodes in each of the paths 104 are initialized. In yet other embodiments, all the nodes in the network 100 are initialized. The queue depth collection feature enables the second node N1-2 to collect queue depth information and, in some embodiments, other performance metrics using protocols such as IOAM. The initialization may be performed by a node or device of the first path 110 or other location in the network 100 transmitting instructions (e.g., software) to the processor 304 that cause the processor 304 to run or initialize the queue depth information generator 310 and the BFD echo packet generator 312. In some embodiments, the first node N1-1 or the sixth node N1-6 transmits the initialization instructions. The BFD echo feature may configure the second node N1-2 to send BFD echo packets at 1 ms intervals, for example.

In operational block 404, one or more of the nodes 208 start collecting queue depth information. Other nodes in the first path 110 and nodes in other paths may also start collecting queue depth information. For example, the second node N1-2 may collect queue depth information from the third node N1-3 and/or the second node N1-2. The third node N1-3 may collect queue depth information for the third node N1-3. The fourth node N1-4 may collect queue depth information for the fourth node N1-4. The collected queue depth information and other performance metrics may be stored in the memory 306 of each of the nodes 208 or other devices.

In operational block 406, outgoing BFD echo packets are transmitted by one or more of the nodes. For example, outgoing BFD echo packets may be transmitted from the first node N1-1 to the second node N1-2. In addition, the second node N1-2 may transmit outgoing BFD echo packets to the third node N1-3.

In operational block 408, the queue depth information is appended to return BFD echo packets. Other performance metrics may also be appended to the return BFD echo packets. This process may be referred to as encapsulating the queue depth information with the BFD echo packets. With regard to the second node N1-2, the second node N1-2 may receive an outgoing BFD echo packet transmitted from the first node N1-1. Prior to returning the return BFD echo packet back to the first node N1-1, the network interface 302 or other device in the second node N1-2 may append queue depth information and/or other performance metrics collected by the queue depth information generator 310 or stored in the memory 306 to the return BFD echo packet. In some embodiments, the queue depth information and/or other performance metrics may be in the form of IOAM data.

In operational block 410, the return BFD echo packets with the appended queue depth information and/or other performance metrics are transmitted back to the originating node. When applied to the second node N1-2, the first node N1-1 has transmitted an outgoing BFD echo packet to the second node N1-2. The second node N1-2 then transmits or returns a return BFD echo packet with the appended queue depth information and/or other performance metrics back to the first node N1-1. In a similar manner if the second node N1-2 transmitted an outgoing BFD echo packet to the third node N1-3, the third node N1-3 transmits a return BFD echo packet with appended queue depth information and/or other performance metrics back to the second node N1-2.

The queue depth information may be received in the first node N1-1 from all the paths 104 (FIG. 1) in the network 100. For example, the queue depth information transmission techniques described with reference to the first path 110 in FIG. 1 may be applied to the second path 112 and the third path 114. Thus, the first node N1-1 may have queue depth information of all nodes 208 and paths 104 in the network 100.

In some embodiments, the processor 304 may append a first portion of the queue depth information and/or performance metrics to a first return BFD echo packet and a second portion of the queue depth information and/or performance metrics to a second return BFD echo packet in order to minimize packet sizes. The first portion of the queue depth information may include queue depth information collected during a first period and the second portion of the queue depth information may include queue depth information collected during a second period. In other embodiments, the first portion of the queue depth information may include queue depth information of a first portion of the first path 110 and the second portion of the queue depth information may include queue depth information of a second portion of the first path 110 as described in greater detail herein.

If all the queue depth information and performance metrics were appended to a single return BFD echo packet, the packet may be large enough to hamper the operation of the network 100, especially as the network 100 grows. This issue may be illustrated by situations in FIG. 2 where the sixth node N1-6 sends queue depth information to the fifth node N1-5 on a return BFD echo packet. The fifth node N1-5 may aggregate queue depth information received from the sixth node N1-6 with queue depth information of the fifth node N1-5 and send the aggregated queue depth information to the fourth node N1-4 on a return BFD echo packet. This aggregation may continue with all the nodes until a BFD return packet with all the aggregated queue depth information is transmitted from the second node N1-2 to the first node N1-1. All the aggregated queue depth information appended to the return BFD echo packet to the first node N1-1 may increase latency in the first path 110 and create other problems. In order to overcome these situations, the nodes may only append small portions of the queue depth information and/or performance metrics to individual return BFD echo packets. These small portions may, for example, pertain to queue depth information and/or performance metrics of a single node of the network 100.

In operational block 412, the queue depth information is analyzed. For example, queue depth information received at the first node N1-1 may be analyzed to determine the optimal communications paths between the first node N1-1 and the sixth node N1-6. Thus, the first node N1-1 may determine the optimal communications path based at least in part on the received queue depth information from all the paths 104 (FIG. 1). The optimal communications path determined by the first node N1-1 may continually change as queue depths in the nodes of the network 100 change.

In operational block 414, communications between the first node N1-1 and the sixth node N1-6 may be adjusted based on the analysis of the queue depth information. Because the BFD echo packets are sent at very high rates, such as between every millisecond and every ten milliseconds, the first node N1-1 may receive queue depth information in virtual real time. Thus, determining optimal communication paths may be performed in real time as described herein.

In some embodiments, the network 100 may use dynamic load balancing to distribute data communications between a plurality of communications paths. Dynamic load balancing uses algorithms that take into account the current state of each server or node in a network to distribute traffic accordingly. There are a plurality of different algorithms that may be used by servers and other nodes to distribute the traffic. However, conventional load balancing algorithms base the distribution of traffic on a state of the nodes as of a time when the server receives queue depth information, which may be delayed depending on the methods used to transmit queue depth information throughout the network. The devices and methods described herein provide for much faster load balancing responses because the queue depth information is received in real time.

As described above, the first node N1-1 may receive queue depth information pertaining to the nodes in the network 100 faster than in conventional networks. Therefore, in embodiments where the first node N1-1 is a server requiring fast data communications with the sixth node N1-6, which may be a storage device or the like, the first node N1-1 is able balance network traffic faster than networks using conventional nodes and queue depth information transmission methods. For example, if the first node N1-1 is a server running artificial intelligence (AI) or machine learning (ML) algorithms, the first node N1-1 is better able to maintain consistently high data traffic than with networks using conventional nodes and conventional queue depth information transmission techniques.

In some embodiments, the first node N1-1 may monitor the queue depth information in real time and may anticipate increases and/or decreases in network traffic. Thus, the first node N1-1 may determine that the queue depth in a node in the first path 110 is increasing slightly. The first node N1-1 may act on the queue depth information proactively to change load balancing in the network 100 so applications operating via the first node N1-1 will continue to operate properly. For example, the first node N1-1 may transfer some traffic to the second path 112 and/or the third path 114 to balance the network traffic based on the queue depth increases in the first path 110. In some embodiments, the queue depth information may be input to an AI model or the like that is trained to recognize changes in latency and the like as a result of changes in queue depth. The AI model may then be able to configure appropriate load balancing.

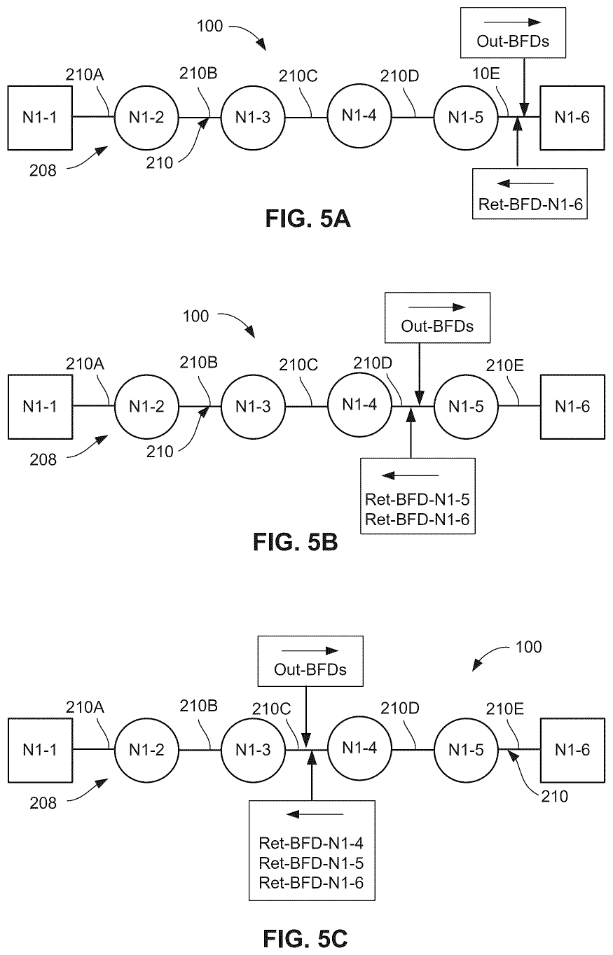

As briefly described above, the nodes 208 may be programmed to transmit or relay the queue depth information and/or performance metrics in a daisy chain or round robin format so that large return BFD echo packets that have queue depth information pertaining to several of the nodes 208 are not continually transmitted throughout the network 100. Additional reference is made to FIGS. 5A-5C, which illustrate an example of the round robin or daisy chain data transmission in the first path 110. The following example may commence with the sixth node N1-6 collecting and/or generating queue depth information. As shown in FIG. 5A, the fifth node N1-5 may transmit outgoing BFD echo packets to the sixth node N1-6 and the sixth node N1-6 may transmit return BFD echo packets with queue depth information pertaining to the sixth node N1-6.

At this point, the fifth node N1-5 has queue depth information of the fifth node N1-5 and the sixth node N1-6. Referring to FIG. 5B, the fourth node N1-4 may transmit outgoing BFD echo packets to the fifth node N1-5. Queue depth information pertaining to the sixth node N1-6 may be appended to a first return BFD echo packet and transmitted to the fourth node N1-4. Queue depth information pertaining to the fifth node N1-5 may be appended to a second return BFD echo packet and transmitted to the fourth node N1-4.

The fourth node N1-4 now has queue depth information pertaining to the fourth node N1-4, the fifth node N1-5, and the sixth node N1-6 that is to be transmitted to the third node N1-3 via return BFD echo packets. Referring to FIG. 5C, the third node N1-3 transmits outgoing BFD echo packets to the fourth node N1-4. The transmission of the queue depth information to the third node N1-3 may be accomplished using three return BFD echo packets. A first return BDF echo packet may transmit queue depth information of the sixth node N1-6, a second return BFD echo packet may transmit queue depth information of the fourth node N1-4, and a third return BFD echo packet may transmit queue depth information of the fifth node N1-5. In some embodiments, a single BFD return packet may have queue depth information of two or more nodes. Thus, the status of the first path 110 may be transmitted throughout the first path 110 quickly and with minimal effects on latency in the first path 110.

With additional reference to FIG. 1, the queue depth information may be transmitted from all the paths 104 to the first node N1-1 in a round robin format. For example, the first node N1-1 may transmit outgoing BFD echo packets to nodes on the paths 104. With reference to FIG. 2, the first node N1-1 may transmit outgoing BFD echo packets to the second node N1-2 in the first path 110. The first node N1-1 may also transmit outgoing BFD echo packets to adjacent or directly coupled nodes in the second path 112 and the third path 114. In some embodiments, the outgoing BFD packets may be transmitted in a round robin format with a first outgoing BFD echo packet transmitted to a node in the first path 110, then a second outgoing BFD echo packet transmitted to node in the second path 112, and followed with a third BFD echo packet transmitted to node in the third path 114. This round robin may cycle continually. The first node N1-1 is then able to receive queue depth information continually from all the paths 104. Transmission of the queue depth information from the paths 104 to the first node N1-1 may be performed as described in FIGS. 5A-5C.

In other embodiments, the first node N1-1 may request additional queue depth information related to a single path. In such situations, the first node N1-1 may then transmit a plurality of consecutive outgoing BFD echo packets to that path. Such situations may occur if the first node N1-1 detects that a path may have latency issues or other issues caused by the queue depths on nodes in that path. The first node N1-1 is then able to retrieve all the queue depth information of nodes in that path within a few milliseconds, which is virtually real time.

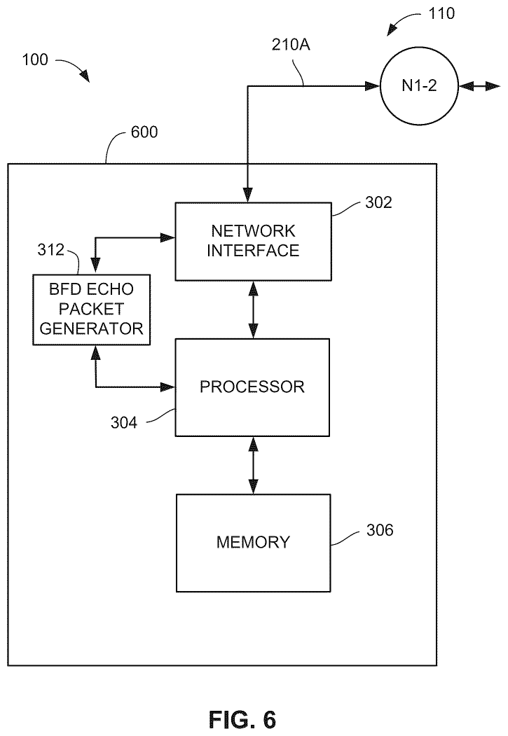

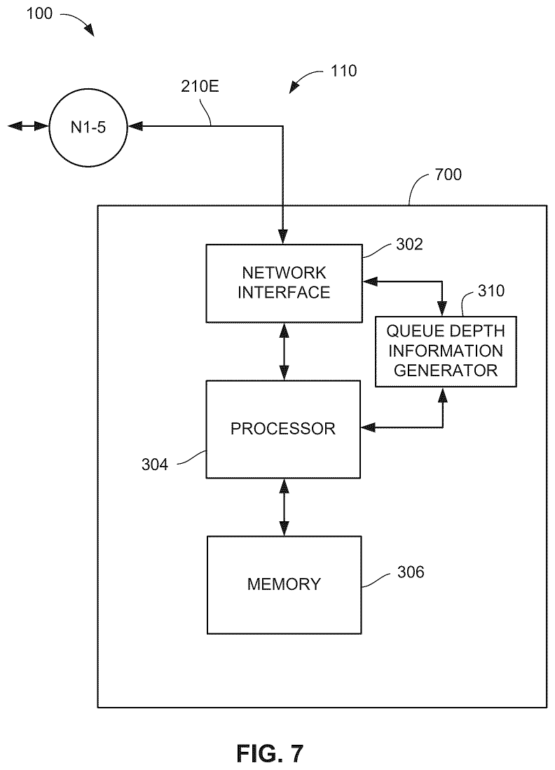

Reference is now made to FIGS. 6 and 7, which illustrate different embodiments of the nodes 208. Not all the nodes 208 in the network 100 may include all the components of the second node N1-2 as described with reference to FIG. 3. Therefore, not all the nodes 208 may perform all the functions described relative to the second node N1-2. Reference is made to FIG. 6, which illustrates a block diagram of an embodiment of a node 600 that does not include a queue depth information generator. The node 600 may be an upstream end node, such as the first node N1-1 (FIG. 2) that may not generate queue depth information for transmission to other nodes. However, the node 600 may receive queue depth information from other nodes in the paths 104. For example, the node 600 may include the BFD echo packet generator 312 that transmits BFD echo packets to other nodes, such as to the second node N1-2 (FIG. 2). The node 600 then receives return BFD echo packets with appended queue depth information. The node 600 may process the queue depth information as described herein.

Reference is made to FIG. 7, which illustrates an embodiment of a node 700 that does not include a BFD echo packet generator. The node 700 may be similar to embodiments of the sixth node N1-6, but does not include a BFD echo packet generator. The node 700 may be a downstream end node that appends queue depth information to return BFD echo packets, but does not generate outgoing BFD echo packets. The node 700 may acquire queue depth information from IOAM routines or other methods, which may be appended to return BFD echo packets.

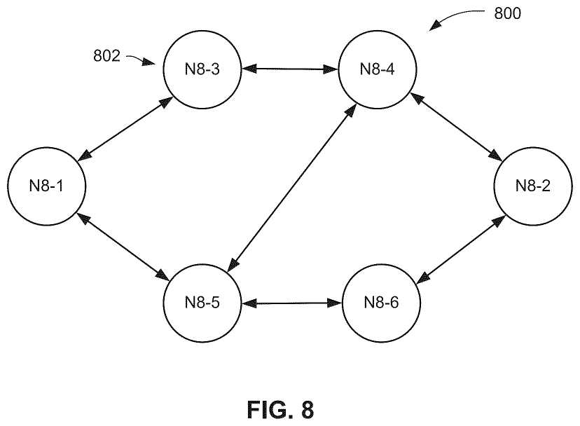

The methods of transmitting queue depth information throughout a network using the above-described nodes may be applied to more sophisticated networks than the network 100 of FIG. 1. Additional reference is made to FIG. 8, which illustrates a network 800 that includes a plurality of different overlapping communications paths between a plurality of nodes 802. In the embodiment of FIG. 8, a first node N8-1 may be an upstream endpoint node and a second node N8-2 may be a downstream endpoint node. For example, the first node N8-1 and/or the second node N8-2 may be servers.

The network 800 may have a plurality of different communication paths between the first node N8-1 and the second node N8-2. A first communication path is via node N8-3, node N8-4, and to node N8-2. A second communication path is via node N8-3, node N8-4, node N8-5, node N8-6, and to node N8-2. A third communication path is via node N8-5, node N8-4, and to node N8-2. A fourth communication path is via node N8-5, node N8-6, and to node N8-2. The first node N8-1 may analyze the queue depth information of the nodes 802 to determine the optimal path for data communications and/or the optimal dynamic load balancing.

The methods and nodes described herein enable the large number of nodes 802 to transmit queue depth information throughout the network 800 without overwhelming the network 800. For example, return BFD echo packets may have queue depth information of one or a few nodes appended to them. In some embodiments, one or more return BFD echo packet may have queue depth information pertaining to one node. Other embodiments may have queue depth information pertaining to two or more nodes appended to the return BFD echo packets so long as the larger return BFD echo packets do not overwhelm the network 800.

During operation of the network 800, the second node N8-2 may collect queue depth information as described herein. For example, the network 800 may use IOAM techniques and other techniques to collect the queue depth information. The fourth node N8-4 and the sixth node N8-6 may transmit outgoing BFD echo packets to the second node N8-2. The second node N8-2 may append queue depth information to return BFD echo packets returning to the fourth node N8-4 and the sixth node N8-6.

The fourth node N8-4 may now have queue depth information pertaining to the second node N8-2 and the fourth node N8-4. The sixth node N8-6 may have queue depth information pertaining to the second node N8-2 and the sixth node N8-6. The third node N8-3 and the fifth node N8-5 may transmit outgoing BFD echo packets to the fourth node N8-4. The fourth node N8-4 may append queue depth information pertaining to the second node N8-2 to a first return BFD echo packet and queue depth information pertaining to the fourth node N8-4 to a second return BFD echo packet. The fourth node N8-4 may do the same with return BFD echo packets to the fifth node N8-5. The fourth node N8-4 may continually receive queue depth information from the second node N8-2 and may continuously transmit the queue depth information to the third node N8-3 and the fifth node N8-5 using a rotational or round robin format. The sixth node may continuously transmit queue depth information in the same manner to the fifth node N8-5.

The third node N8-3 now has queue depth information pertaining to the second node N8-2 and the fourth node N8-4 in addition to the third node N8-3. The fifth node N8-5 now has queue depth information pertaining to the second node N8-2, the fourth node N8-4, and the sixth node N8-6 in addition to the fifth node N8-5. The third node N8-3 and the fifth node N8-5 may use round robin formats to transmit this queue depth information to the first node N8-1. The first node N8-1 may transmit outgoing BFD echo packets to the third node N8-3 and the fifth node N8-5. The third node N8-3 may append queue depth information of the second node N8-2 to a first return BFD echo packet, queue depth information of the fourth node N8-4 to a second BFD echo packet, and queue depth information of the third node N8-3 to a third return BFD echo packet. The fifth node N8-5 may append queue depth information stored therein to return BFD echo packets in a similar manner. The first node N8-1 thus receives queue depth information of the network 800 as a whole after receiving seven return BFD echo packets from the third node N8-3 and the fifth node N8-5. If the first node N8-1 generates BFD echo packets at a rate of one per millisecond, then the first node N8-1 receives queue depth information of the network 800 as a whole every seven milliseconds, which may be considered real time.

The first node N8-1, may continually analyze the queue depth information to continually determine optimal communications paths for transmitting data and/or for dynamic load balancing. When these methods are applied to transmitting data from the first node N8-1 to the second node N8-2, the first node N8-1 may determine that there are queue depth issues with one or more of the nodes 802 and may direct data traffic to minimize use of the one or more nodes. For example, the first node N8-1 may determine that there are queue depth issues with the sixth node N8-6. Based on analysis of the network 800, the first node N8-1 may determine that a communications path that reduces traffic via the sixth node N8-6 provides the optimal communications path. The first node N8-1 may balance data traffic accordingly. This analysis may be performed by other nodes to determine optimal communications paths within the network 800.

The disclosure has described transmitting queue depth information throughout networks using BFD echo packets. In some embodiments the networks may transmit performance metrics related to the networks via the BFD echo packets. The performance metrics may include latency, jitter, packet loss and other metrics that may affect performance of the networks. In some embodiments, the performance metrics may include, but are not limited to node temperature and energy consumed by the nodes. The energy consumption may be in categories such as renewable energy and non-renewable energy consumed. In some embodiments, the performance metrics may be transmitted throughout the network on the same BFD echo packets as the queue depth information.

The additional performance metrics may be factors as to which paths (e.g., paths 104) are used for data transmission. For example, if a node is hot, the analyses for path selection may determine that the node may be on the verge of failure and may direct data traffic away from that node. Energy consumption may be a factor in costs associated with the networks, especially high traffic networks such as those used for AI and ML. Data may be directed to lower energy consumption networks. In other embodiments, energy costs may be a function of time, such as being more expensive during daytime hours. In such embodiments, decisions may be made to transmit data via low energy nodes during peak energy cost periods.

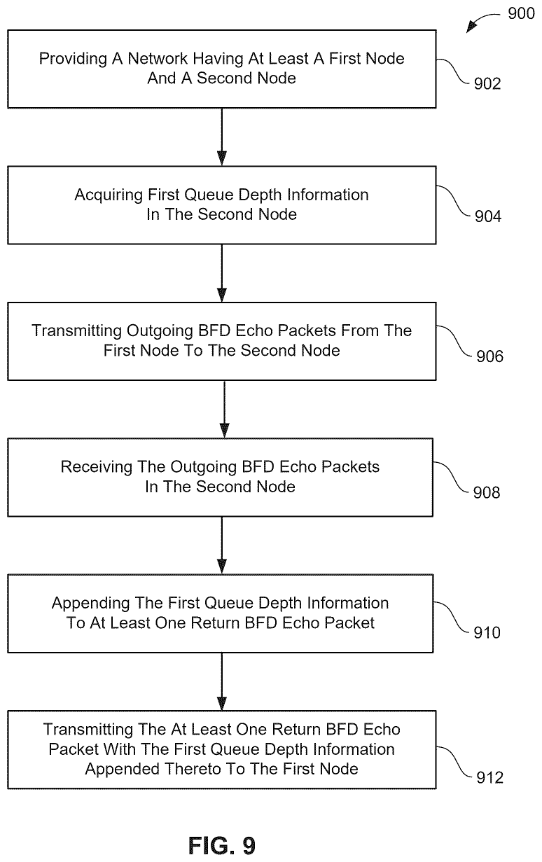

Reference is now made to FIG. 9, which illustrates a method 900 of operating a network (e.g., network 100 or network 800). The method 900 includes, at operational block 902, providing a network having at least a first node and a second node. The method 900 includes, at operational block 904, acquiring first queue depth information in the second node. The method 900 includes, at operational block 906, transmitting outgoing BFD echo packets from the first node to the second node. The method 900 includes, at operational block 908, receiving the outgoing BFD echo packets in the second node. The method 900 includes, at operational block 910, appending the first queue depth information to at least one return BFD echo packet. The method 900 includes, at operational block 912, transmitting the at least one return BFD echo packet with the first queue depth information appended thereto to the first node.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope consistent with the principles and novel features disclosed herein.

What is claimed is:

1. A node of a network, the node comprising:
a network interface configured to receive outgoing bidirectional forward detection (BFD) echo packets transmitted from an originating node and to transmit return BFD echo packets with queue depth information appended thereto back to the originating node;
a queue depth information generator configured to collect queue depth information; and
a processor configured to append the queue depth information to the outgoing BFD echo packets.

2. The node of claim 1, wherein the node is configured to transmit data between a first server and a second server.

3. The node of claim 1, wherein the node is a server.

4. The node of claim 1, wherein the queue depth information comprise first queue depth information of the node of the network and second queue depth information of a second node of the network, wherein the network interface is configured to transmit a first return BFD echo packet with the first queue depth information appended thereto and a second return BFD echo packets with the second queue depth information appended thereto to the originating node.

5. The node of claim 1, further comprising a BFD echo packet generator coupled to the network interface and configured to generate outgoing BFD echo packets, and wherein the node is further configured to receive return BFD echo packets having queue depth information appended thereto.

6. The node of claim 5, wherein the processor is further configured to select a communications path for transmitting data based at least in part on the queue depth information.

7. A node of a network, the node comprising:
a network interface configured to receive return bidirectional forward detection (BFD) echo packets with first queue depth information appended thereto from at least a first node of the network; and
a processor coupled to the network interface, wherein the processor is configured to extract the first queue depth information from the return BFD echo packets.

8. The node of claim 7, wherein the network interface is further configured to receive return BDF echo packets from a second node with second queue depth information appended thereto, wherein the processor is further configured to extract the second queue depth information from the return BFD packets, and wherein the first node transfers data in a first communications path of the network and the second node transfers data in a second communications path in the network.

9. The node of claim 8, wherein the processor is further configured to select the first communications path or the second communications path to transmit data from the node based at least in part on the first queue depth information and the second queue depth information.

10. The node of claim 8, wherein the processor is further configured to dynamically balance loads between the first communications path and the second communications path for transmission of data from the node based at least in part on the first queue depth information and the second queue depth information.

11. The node of claim 7, wherein the node is a server.

12. The node of claim 7, wherein the node is configured to transmit data between a first server and a second server.

13. The node of claim 7, further comprising:
a queue depth information generator configured to generate queue depth information,
wherein at least one of the queue depth information generator or the processor is configured to append the queue depth information generated by the queue depth information generator to return BFD echo packets and wherein the network interface is configured to transmit the return BFD echo packets with the appended queue depth information to at least one node.

14. A method of operating a network, the method comprising:
providing a network having at least a first node and a second node;
acquiring first queue depth information in the second node;
transmitting outgoing BFD echo packets from the first node to the second node;
receiving the outgoing BFD echo packets in the second node;
appending the first queue depth information to at least one return BFD echo packet; and
transmitting the at least one return BFD echo packet with the first queue depth information appended thereto to the first node.

15. The method of claim 14, further comprising:
acquiring second queue depth information of a third node of the network;
transmitting outgoing BFD echo packets from the second node to the third node;
receiving the outgoing BFD echo packets in the third node;
appending the second queue depth information to at least one return BFD echo packet; and
transmitting the at least one return BFD echo packet with the second queue depth information appended thereto from the third node to the second node.

16. The method of claim 15, further comprising:
receiving a first outgoing BFD echo packet in the second node transmitted from the first node;
appending the first queue depth information to a first return BFD echo packet;
transmitting the first return BFD echo packet with the first queue depth information appended thereto from the second node to the first node;
receiving a second outgoing BFD echo packet in the second node transmitted from the first node;
appending the second queue depth information to a second return BFD echo packet; and
transmitting the second return BFD echo packet with the second queue depth information appended thereto from the second node to the first node.

17. The method of claim further comprising:
acquiring third queue depth information at a fourth node;
transmitting outgoing BFD echo packets from the first node to the fourth node;
receiving the outgoing BFD echo packets in the fourth node;
appending the third queue depth information to at least one return BFD echo packet; and
transmitting the at least one return BFD echo packet with the third queue depth information appended thereto to the first node.

18. The method of claim 17, wherein the second node is in a first communications path and the fourth node is in a second communications path, and further comprising transmitting data via the first communications path or the second communications path based at least in part on the first queue depth information and the third queue depth information.

19. The method of claim 17, wherein the second node is in a first communications path and the fourth node is in a second communications path, and further comprising dynamically balancing data communications between the first communications path and the second communications path based at least in part on the first queue depth information and the third queue depth information.

20. A network for transmitting data, the network comprising:
a first node; and
a second node,
wherein:
the first node is configured to: transmit outgoing BFD echo packets to the second node; receive return BFD echo packets from the second node; and extract first queue depth information from the return BFD echo packets, and
the second node is configured to: receive the outgoing BFD echo packets from the first node; append the first queue depth information to the return BFD echo packets;
transmit the return BFD echo packets back to the first node.

21. The network of claim 20, further comprising a third node configured to:
collect second queue depth information;
receive outgoing BFD echo packets transmitted from the first node;
append the second queue depth information to return BFD echo packets; and
transmit the return BFD echo packets back to the first node,
wherein:
the second node is in a first communications path and the third node is in a second communications path; and
the first node is further configured to:
receive return BFD echo packets from the third node;
extract the second queue depth information from the return BFD echo packets from the third node; and
determine to transmit data via the first communications path or the second communications path based at least in part on the first queue depth information and the second queue depth information.
